(19) United States
(12) Patent Application Publication
(10) Pub. No.: US 2010/0091246 A1
(43) Pub. Date: Apr. 15, 2010

(54) SINGLE PROJECTION DISPLAY DEVICE

(76) Inventor: Chikara YAMAMOTO, Saitama-shi (JP)

Correspondence Address: BIRCH STEWART KOLASCH & BIRCH, PO BOX 747, FALLS CHURCH, VA, 22040-0747, US

(21) Appl. No.: 12/569,644

(22) Filed: Sep. 29, 2009

(30) Foreign Application Priority Data
Oct. 10, 2008 (JP) P2008-263912

(51) Int. Cl. G03B 21/28; G03B 21/14

(52) U.S. Cl. 353/20; 353/98

(57) ABSTRACT

Disclosed is a single projection display device in which illumination light that is emitted from a light source unit and is linearly-polarized is reflected at a right angle by a PBS and is then incident on a single reflective liquid crystal display device, and modulated light passes through the PBS and is then projected onto a screen by a projection lens. An intersection point between the optical axis of the projection lens and the reflective liquid crystal display device deviates from the center of the surface of the reflective liquid crystal display device. The normal line of a polarized light separation plane is parallel to a plane that is vertical to another plane formed by a surface normal at the center of the surface of the reflective liquid crystal display device and the optical axis of the projection lens and that includes the optical axis of the projection lens.

### CROSS-REFERENCE TO RELATED APPLICATIONS

This application is based upon and claims the benefit of priority from the Japanese Patent Application No. 2008-263912 filed on Oct. 10, 2008; the entire contents of which are incorporated herein by reference.

### BACKGROUND OF THE INVENTION

1. Field of the Invention

The present invention relates to a projection image display device that enlarges and projects an image displayed on a reflective light valve onto a screen, and more particularly, to a handheld-type single projection display device having high portability.

2. Description of the Related Art

In recent years, a reflective light valve, such as a reflective liquid crystal device (LCOS) or a DMD (digital micro device), capable of more improving an aperture ratio than a transmissive light valve and meeting demands for high resolution and high illuminance has been used as a light valve provided in a projector.

It is expected in the near future that the projector, having the reflective light valve provided therein, will require a handheld-type single projection display device having high portability.

It is important to reduce the size of the device in order to configure a projector having high portability. In particular, it is effective to reduce the thickness of a device in a direction vertical to the optical axis of a projection optical system, generally, in the vertical direction of a device case.

That is, it is necessary to reduce the thickness of the projector in the vertical direction of the case thereof in terms of easy viewing or high portability when the projector is placed on, for example, a table to project images or when the projector projects images while being held in the user's hand.

For example, Japanese Patent No. 3508011 and JP-A-2005-84456 disclose projection display devices capable of improving portability. In the projection display devices, a reduction side is telecentric, and a certain amount of space to perform color composition or to separate illumination light from projection light is ensured on the rear side of a projection lens, thereby reducing the size of the projection lens. In this way, the overall size of the device is reduced.

However, in Japanese Patent No. 3508011 and JP-A-2005-84456, the size of the projection lens, particularly, the thickness of the projection lens is reduced in order to reduce the size of the projector. Therefore, it is insufficient to significantly reduce the size of a device case, and more drastic measures are needed.

### SUMMARY OF THE INVENTION

The invention has been made in order to solve the above-mentioned problems, and an object of the invention is to provide a single projection display device having a small thickness in the vertical direction of a device case, a small size, high portability, and a high projection performance.

According to an aspect of the invention, a single projection display device includes a light source, a reflective light valve, an optical path separation plane and a projection lens. The reflective light valve is illuminated with illumination light emitted from the light source and emits modulated light corresponding to a image signal. The optical path separation plane separates the illumination light and the modulated light on an optical path between the light source and the reflective light valve. The projection lens enlarges and projects image information carried on the modulated light. An intersection point between an optical axis of the projection lens and the reflective light valve deviates from a center of a surface of the reflective light valve. A plane A is formed by a first surface normal at the center of the surface of the reflective light valve and the optical axis of the projection lens. A plane B is vertical to the plane A and includes the optical axis of the projection lens. A second surface normal to a surface of the optical path separation plane is parallel to the plane B.

The optical path separation plane may be a polarized light separation plane, and the illumination light may be polarized to be incident on the optical path separation plane.

The optical path of an illumination optical unit that illuminates the reflective light valve and includes the light source may be arranged along the plane B.

The optical path separation plane may be arranged on the optical path between the projection lens and the reflective light valve. In a lens, closest to the reflective light valve, of the projection lens, a portion that is disposed opposite to the center of the surface of the reflective light valve across the optical axis may be removed such that an outer circumference of the lens has a non-circular shape, as viewed from the optical path separation plane.

The light source may include an LED.

The light source may include a laser.

The projection lens may satisfy Conditional expressions 1 and 2 given below:

[Conditional expression 1]

20<S/OBJ<65, and

[Conditional expression 2]

2.5<β/S<10.0

where S indicates a maximum length (inch) of a magnification-side image, OBJ indicates a magnification-side projection distance (m), and β indicates a magnifying power.

The projection lens may satisfy Conditional expressions 1′, 2, and 3 given below:

[Conditional expression 1′]

35<S/OBJ<140,

[Conditional expression 2]

2.5<β/S<10.0, and

[Conditional expression 3]

3.0<S<10.0

where S indicates a maximum length (inch) of a magnification-side image, OBJ indicates a magnification-side projection distance (m), and β indicates a magnifying power.

The term ‘non-circular shape’ means that the shape of each lens is not circular, as viewed in a traveling direction of a light beam. In addition, ‘the maximum length (inch)’ of the magnification-side image means a length of the longest segment among segments that can be drawn in the image. For example, when an image has a rectangular shape, the maximum length is a length of a diagonal line of the image. When an image has a circular shape or a semicircular shape, the maximum length is a diameter of the image.

According to the single projection display device of the above-mentioned aspect, the intersection point between the optical axis of the projection lens and the reflective light valve deviates from the center of the surface of the reflective light valve. the plane A is formed by the first surface normal at the center of the surface of the reflective light valve and the optical axis of the projection lens, the plane B is vertical to the plane A and includes the optical axis of the projection lens, and the second surface normal to the surface of the optical path separation plane is parallel to the plane B.

With the above-mentioned structure, it is possible to project an image shifted in the vertical direction (thickness direction) of a device case and reduce the thickness of the device case in the vertical direction (thickness direction). Therefore, it is possible to achieve a single projection display device having a small size, high portability, and a high projection performance.

Therefore, the above-mentioned structure is very useful in terms of easy viewing and high portability when a projector is placed on, for example, a table to project images or when the projector projects images while being held in the user's hand.

### BRIEF DESCRIPTION OF THE DRAWINGS

FIGS. 1A and 1B are diagrams illustrating the structure of a single projection display device according to Example 1, in which FIG. 1A shows the optical arrangement of the single projection display device, as viewed from the upper side, and FIG. 1B shows the optical arrangement of the single projection display device, as viewed from the side;

FIGS. 2A and 2B are diagrams illustrating the structure of a single projection display device according to Example 2, in which FIG. 2A shows the optical arrangement of the single projection display device, as viewed from the upper side, and FIG. 2B shows the optical arrangement of the single projection display device, as viewed from the side; and

FIGS. 3A and 3B are diagrams illustrating the structure of a single projection display device according to a comparative example, in which FIG. 3A shows the optical arrangement of the single projection display device, as viewed from the upper side, and FIG. 3B shows the optical arrangement of the single projection display device, as viewed from the side.

### DESCRIPTION OF THE PREFERRED EMBODIMENTS

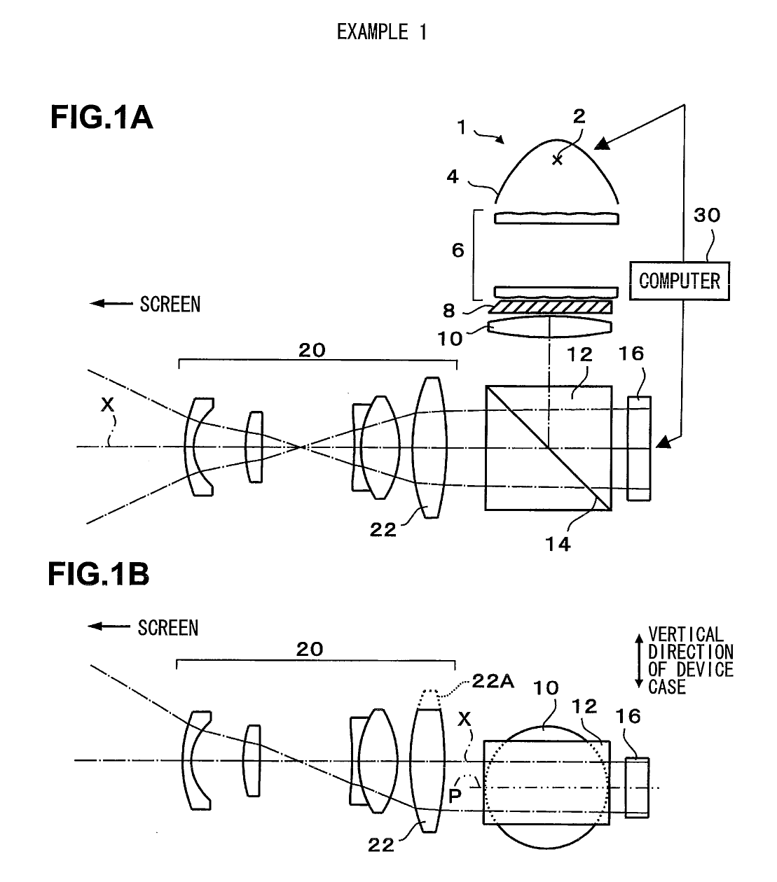

Hereinafter, exemplary embodiments of the invention will be described with reference to the accompanying drawings. FIGS. 1A and 1B are diagrams illustrating the structure of a single projection display device according to Example 1, which is a representative example of an embodiment of the invention, in which FIG. 1A shows the optical arrangement of the device according to Example 1, as viewed from the upper side, and FIG. 1B shows the optical arrangement of the device, as viewed from the side. In the single projection display device, a polarized beam splitter (hereinafter, referred to as a PBS) 12 reflects linearly-polarized illumination light emitted from a light source unit 1 at a right angle such that the illumination light is incident on a single reflective liquid crystal display device (LCOS) 16 having a rectangular display surface, and the reflective liquid crystal display device 16 modulates the illumination light. Then, the modulated light passes through the PBS 12 and is then projected onto a screen (not shown) by a projection lens 20. An integrator unit 6, a polarizing element (comb type filter) 8, and a condenser lens 10 are provided between the light source unit 1 and the PBS 12. In addition, FIGS. 1A and 1B schematically illustrate the light source unit 1 including a light-emitting member 2 and a reflector 4. A polarized light separation plane 14 that separates the light modulated by the reflective liquid crystal display device 16 from the illumination light emitted from the light source unit 1 is provided on a diagonal surface of the PBS 12.

In this embodiment, the single projection display device is provided, and various methods of projecting color images using the single projection display device may be used. For example, the light source unit 1 may include three types of LEDs, that is, R, G, and B LEDs as the light-emitting member 2, the LEDs may be sequentially turned on in a time division manner, and corresponding color images may be displayed on the reflective liquid crystal display device 16 in synchronization with the turning-on of the LEDs.

In this case, as shown in FIG. 1A, it is preferable to provide a computer 30 for synchronizing the turn-on timing of the light-emitting member 2 with the display timing of an image on the reflective liquid crystal display device 16.

In the device, an intersection point between the optical axis of the projection lens 20 (which is represented by a segment X in FIG. 1B) and the reflective liquid crystal display device 16 deviates from the center of the display surface of the reflective liquid crystal display device 16. In addition, in the device, when a plane A (which is aligned with the paper of FIG. 1B) which is formed by (i) a surface normal (which is represented by a segment P in FIG. 1B) at the center of the display surface of the reflective liquid crystal display device 16 and (ii) the optical axis X of the projection lens 20 is considered, the polarized light separation plane 14 is arranged such that a normal to the polarized light separation plane 14 is parallel to a plane B that is vertical to the plane A and that includes the optical axis X of the projection lens 20.

The central axis of an illumination light beam emitted from the light source unit 1 and the surface normal P at the center of the display surface of the reflective liquid crystal display device 16 are arranged such that they are substantially aligned with each other in the vertical direction of the device (a direction vertical to the paper of FIG. 1B). The optical axis X of the projection lens 20 is shifted upward in the vertical direction. The ratio of a long side to a short side of the display surface of the reflective liquid crystal display device 16 is set to, for example, 16:9 or 4:3 according to the aspect ratio of a television screen, and the shift direction of the optical axis X of the projection lens 20 is aligned with the direction in which the short side extends.

In this way, it is possible to reduce the thickness of a device case in the vertical direction and thus reduce the size of the device case.

In the device according to this embodiment, the optical path of an illumination optical system illuminating the reflective liquid crystal display device 16 is arranged along the plane B. In this way, it is possible to reduce the thickness of a device case in the vertical direction and thus reduce the size of the device case.

Further, preferably, the polarized light separation plane 14 is provided on the optical path between the projection lens 20 and the reflective liquid crystal display device 16, and a portion 22A of a lens 22 that is disposed opposite to the center of the reflective liquid crystal display device 16 across the optical axis X of the projection lens 20 and is furthest away from the reflective liquid crystal display device 16 is removed such that the distance from the optical axis X is small. That is, it is preferable that the lens 22 be formed such that the outer circumference thereof has a non-circular shape, as viewed from the polarized light separation plane 14 (a D-cut is performed).

According to this structure, it is possible to reduce the thickness of a device case in the vertical direction and thus reduce the size thereof according to the size of the portion 22A removed from the lens 22.

As described above, as can be seen from FIGS. 1A and 1B, the PBS 12 has a small thickness in the vertical direction. As shown in FIGS. 1A and 1B, the center of the PBS 12 in the vertical direction is substantially aligned with the center of the reflective liquid crystal display device 16 in the vertical direction. Therefore, it is possible to reduce the thickness of a device case in the vertical direction and reduce the size thereof. In addition, it is possible to reduce the weight of a device.

As described above, in recent years, a horizontally long screen having, for example, an aspect ratio of 16:9 has been used. The advantages obtained by the positional relationship between the PBS 12 and the reflective liquid crystal display device 16 according to this embodiment of the invention are more significant as the length of the screen in the horizontal direction is increased.

As in this embodiment, when illumination light emitted from the light source unit 1 is incident on the PBS 12 and then reflected substantially at 90 degrees to the reflective liquid crystal display device 16 by the polarized light separation plane 14, it is preferable that the illumination light be polarized in a stage before the PBS 12 and then be incident on the polarized light separation plane 14 of the PBS 12 as S-polarized light, if necessary. When the S-polarized light is incident on the polarized light separation plane 14, reflection efficiency is improved and the loss of light is prevented.

The light source unit 1 may emit S-polarized light or P-polarized light. In addition, instead of the polarized light separation plane 14, a simple half mirror may be provided as an optical path separation plane. However, it is preferable to use the above-mentioned polarized light separation plane in terms of illumination efficiency.

It is preferable that the projection lens satisfy Conditional expressions 1 and 2 given below:

[Conditional expression 1]

20<S/OBJ<65, and

[Conditional expression 2]

2.5<β/S<10.0

(where S indicates the maximum length (inch) of a magnification-side image, β indicates a magnifying power, and OBJ indicates a magnification-side projection distance (m)).

If the ratio is beyond the range of Conditional expression 1, it is difficult to appropriately set a projection screen size and a projection distance. That is, if the ratio is greater than the upper limit of Conditional expression 1, the projection size is excessively large, resulting in a dark image, or the projection distance is too small for many people to view the projection screen at the same time. On the other hand, if the ratio is less than the lower limit, the projection size is too small to obtain the effect of magnification projection, or the projection distance is excessively large, resulting in a dark image.

Conditional expression 2 means that a panel size of 0.1 inch to 0.4 inch is used when all aberrations are not considered. In recent years, liquid crystal display panels having a size of 0.6 to 0.7 inch or 1.3 inches have been generally used. Therefore, a liquid crystal display panel having a diagonal size that is half or less of the above-mentioned size is required.

If the ratio is beyond the range of Conditional expression 2, it is difficult to prevent an increase in the size of a device and improve illumination efficiency and the resolution of a screen. That is, if the ratio is greater than the upper limit of Conditional expression 2, illumination efficiency is lowered according to the Etendue theory, or it is difficult to obtain a high-resolution screen. On the other hand, if the ratio is less than the lower limit, the size of a device increases, and it is difficult to manufacture a projection display device having high portability.

When Conditional expressions 1 and 2 are satisfied, it is possible to manufacture a projection display device that projects a projection image having a size of, for example, 20 to 40 inches onto the screen that is about 1 m away from the projection display device.

When a handheld projection display device that has a screen integrated thereinto and projects a projection image having a size of about 3 to 10 inches is manufactured, it is preferable that the projection display device satisfy Conditional expressions 1′, 2, and 3 given below, instead of Conditional expressions 1 and 2:

[Conditional expression 1′]

35<S/OBJ<140,

[Conditional expression 2]

2.5<β/S<10.0, and

[Conditional expression 3]

3.0<S<10.0

(where S indicates the maximum length (inch) of a magnification-side image, β indicates a magnifying power, and OBJ indicates a magnification-side projection distance (m)).

When Conditional expressions 1′, 2, and 3 are satisfied, it is possible to achieve a handheld single projection display device having a very small size.

According to the single projection display device, it is possible to obtain the effect of preventing an increase in the size of a device and improving illumination efficiency and the resolution of a screen by Conditional expression 1′, which is the same effect as that in Conditional expression 1, and the effect of appropriately setting the projection screen size and the projection distance by Conditional expression 2.

If Conditional expression 3 is not satisfied, it is difficult to obtain an appropriate light valve size. That is, when Conditional expression 3 is satisfied, the size of the light valve is not excessively small, and a projection image is not excessively dark.

Any structure may be used as long as it can obtain substantially the same operation as the above-described embodiment even when a mirror is provided on the optical path between the PBS 12 and the reflective liquid crystal display device 16. This structure is also included in the above-described embodiment.

Other reflective light valves, such as a DMD, may be used instead of the reflective liquid crystal display device 16. The reflective liquid crystal display device (LCOS) has a small size and a high resolution, and the DMD has a high brightness. Therefore, the devices may be appropriately selected depending on the situation.

An LED or a semiconductor laser may be used as the light-emitting member 2 of the light source unit 1. In this case, it is possible to reduce the size of a device.

In FIG. 1B, the portion 22A of the lens 22, closest to the polarized light separation plane 14, of the projection lens 20 is removed such that the outer circumference of the lens 22 has a non-circular shape, as viewed from a reduction side or a magnification side. However, portions of the other lenses in the projection lens 20 may be removed such that the outer circumferences of the lenses have non-circular shapes, as viewed from the polarized light separation plane 14.

### EXAMPLES

Next, examples of the invention will be described.

### Example 1

As described above, FIGS. 1A and 1B are diagrams illustrating the structure of the single projection display device according to Example 1. The structure of the device will be described in detail below.

In the light source unit 1, a beam emitted from the light-emitting member 2 is reflected into light substantially parallel to the optical axis by a paraboloidal reflector 4, and the parallel light is incident on the integrator unit 6. The integrator unit 6 uniformizes the intensity distribution of illumination light in a cross-section orthogonal to the optical axis X, and is a fly-eye integrator including a pair of fly-eyes each of which includes a plurality of lenses two-dimensionally arranged and is aligned in two optical axis directions.

As a polarizing unit that converts illumination light into linearly-polarized light vibrated in one direction, a comb type filter 8 is provided on the rear stage of the integrator unit 6. The comb type filter 8 includes a beam splitter that separates incident non-polarized illumination light into first polarized light and second polarized light having polarized components orthogonal to each other, a mirror that reflects one of the first polarized light and the second polarized light separated by the beam splitter, and a phase plate that aligns one of the first polarized light and the second polarized light in the polarization direction of the other polarized light, and emits non-polarized illumination light as light including only the polarized components of one of the first polarized light and the second polarized light.

The comb type filter 8 is arranged on the emission side of the fly-eyes of the display device. This position is close to a position where a plurality of secondary light source images corresponding to the number of fly-eyes divided are generated, and the phase plate of the comb type filter 8 corresponds to each fly-eye. In Example 1, all beams emitted from the comb type filter 8 are S-polarized by the polarized light separation plane 14 in the rear stage of the comb type filter.

Partial beams emitted from the comb type filter 8 are condensed by the condenser lens 10 so as to overlap each other in an illuminated region and then incident on the PBS 12.

The illumination light is reflected substantially at 90 degrees by the polarized light separation plane 14 of the PBS 12 and reaches the reflective liquid crystal display device 16. As described above, in Example 1, all the beams emitted from the comb type filter 8 are S-polarized by the polarized light separation plane 14 and then reflected by the polarized light separation plane 14 to be incident on the reflective liquid crystal display device 16. Meanwhile, the modulated light from the reflective liquid crystal display device 16 is P-polarized. Therefore, substantially the entire illumination light passes through the polarized light separation plane 14 and travels toward the projection lens 20.

In the device, the intersection point between the optical axis X of the projection lens 20 and the reflective liquid crystal display device 16 deviates from the center of the display surface of the reflective liquid crystal display device 16. In addition, the plane A (which is aligned with the paper of FIG. 1B) is formed by the surface normal P at the center of the display surface of the reflective liquid crystal display device 16 and the optical axis X of the projection lens 20. The plane B (which is vertical to the paper of FIG. 1B) is vertical to the plane A and includes the optical axis X of the projection lens 20. The normal to the polarized light separation plane 14 is parallel to the plane B.

The portion 22A of the lens 22, closest to the polarized light separation plane 14, of the projection lens 20 is removed such that the outer circumference of the lens 22 has a non-circular shape, as viewed in the optical axis direction.

### Example 2

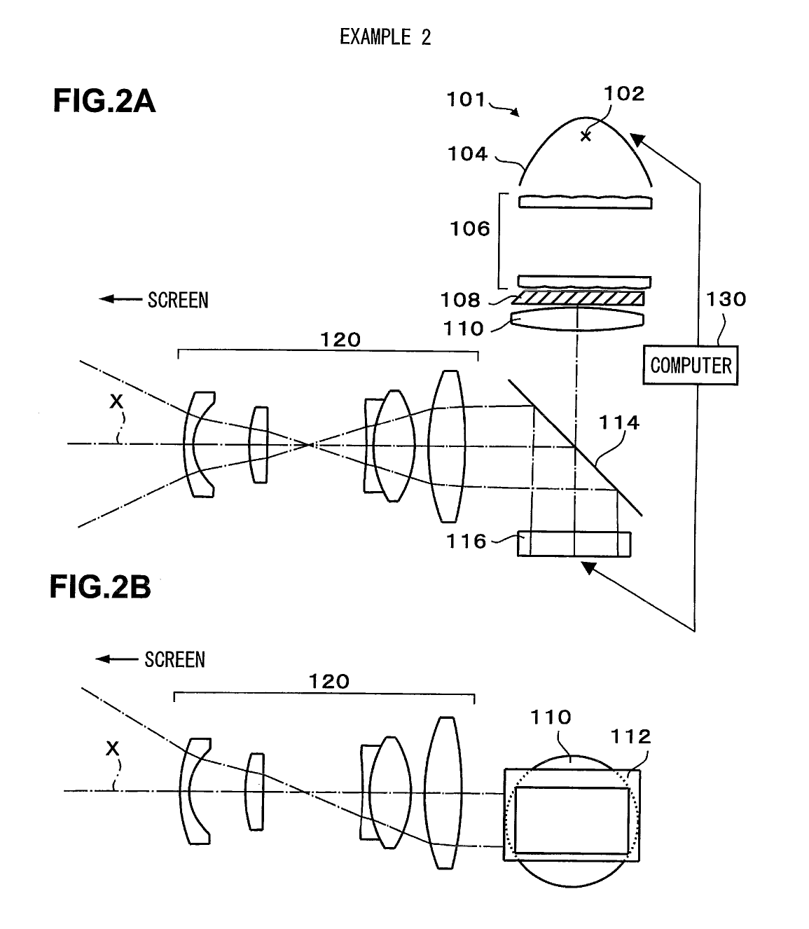

The structure of a single projection display device according to Example 2 is shown in FIGS. 2A and 2B. FIG. 2A shows the optical arrangement of the device according to Example 2, as viewed from the upper side, and FIG. 2B shows the optical arrangement of the device according to Example 2, as viewed from the side. The device according to Example 2 has substantially the same structure as the device according to Example 1, and has substantially the same operation and effect as those of the device according to Example 1. In Example 2, components having the same functions as those in Example 1 are denoted by reference numerals obtained by adding 100 to the reference numerals of the components in Example 1, and a detailed description thereof will be omitted.

In Example 2, a polarized light separation plane 114 is formed by a wire grid, but is not provided in the PBS 12 unlike Example 1. As such, when the polarized light separation plane 114 is formed by the wire grid, it is possible to improve the transmission/reflection angle characteristics of light.

In Example 2, illumination light emitted from a light source unit 101 passes through the polarized light separation plane 114 and reaches a reflective liquid crystal display device 116. In Example 2, beams emitted from a comb type filter 108 are P-polarized by the polarized light separation plane 114. Therefore, substantially the entire illumination light passes through the polarized light separation plane 114 and is then incident on the reflective liquid crystal display device 116. Meanwhile, modulated light emitted from the reflective liquid crystal display device 116 is S-polarized. Therefore, substantially the entire illumination light is reflected by the polarized light separation plane 114 and travels toward the projection lens 120.

In Example 2, no portion of each lens in the projection lens 120 is removed, and the outer circumference of each lens has a circular shape, unlike Example 1.

### COMPARATIVE EXAMPLE

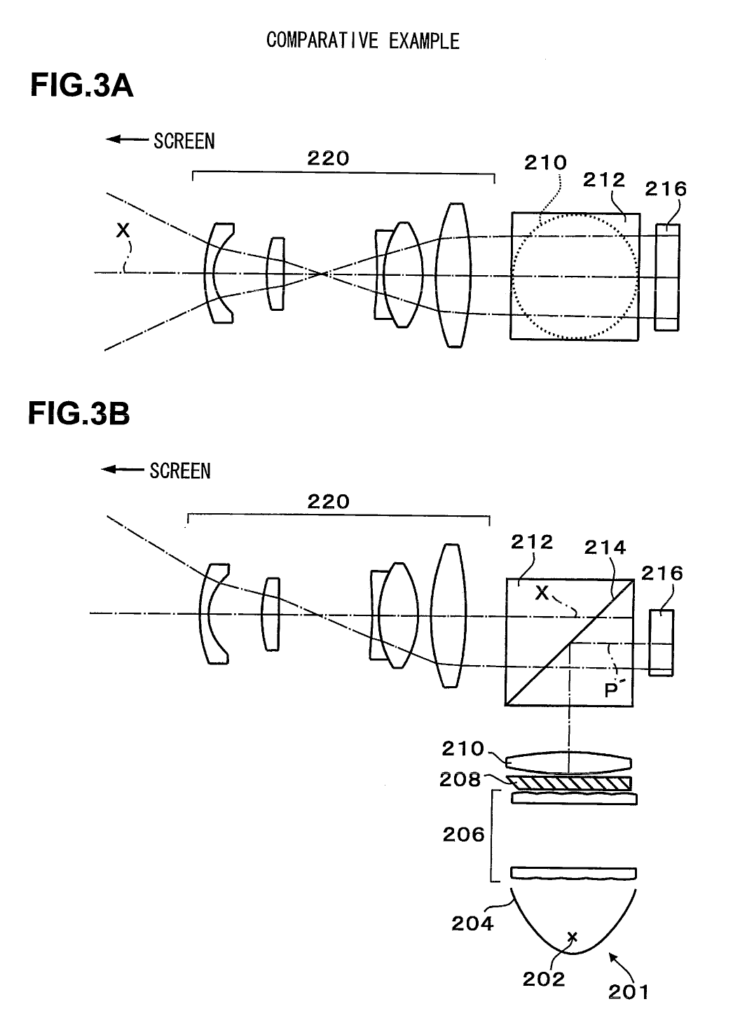

FIGS. 3A and 3B show a comparative example of Examples 1 and 2. FIG. 3A shows the optical arrangement of a device according to the comparative example, as viewed from the upper side, and FIG. 3B shows the optical arrangement of the device, as viewed from the side. The device according to the comparative example has the same structure as the device according to Example 1. In the comparative example, components having the same functions as those in Example 1 are denoted by reference numerals obtained by adding 200 to the reference numerals of the components in Example 1, and a detailed description thereof will be omitted.

In the devices according to Examples 1 and 2, the normal to the polarized light separation plane 14 is parallel to the plane B, which is vertical to the plane A and which includes the optical axis X of the projection lens 20. The plane A is formed by the surface normal P at the center of the display surface of the reflective liquid crystal display device 16 and the optical axis X of the projection lens 20. However, in the comparative example, the normal to the polarized light separation plane 214 is parallel to the plane B (which is aligned with the paper of FIG. 3B), which is parallel to the plane A (which is aligned with the paper of FIG. 3B) and which includes the optical axis X of the projection lens 220. The plane A is formed by a surface normal P′ at the center of the display surface of a reflective liquid crystal display device 216 and the optical axis X of a projection lens 220.

Therefore, in the device according to this comparative example, as can be seen from FIG. 3B, it is difficult to reduce the thickness of the device in the vertical direction.

The integrator unit is not limited to the fly-eye integrator. For example, the integrator unit may be a rod integrator. When the rod integrator is used, incident light does not need to be substantially parallel light, unlike when the fly-eye integrator is used, and the state of a beam emitted from the rod integrator is different from that of a beam emitted from the fly-eye integrator. Therefore, it is preferable to provide members, such as a polarizing element and a lens suitable for the rod integrator.

The single projection display device according to the invention is not limited to the above-described examples, but various modifications and changes of the invention can be made. The light valve or the illumination optical system is not limited to the above-mentioned structure, but other suitable structures may be used.

What is claimed is:

1. A single projection display device comprising:
a light source;
a reflective light valve that is illuminated with illumination light emitted from the light source and emits modulated light corresponding to an image signal;
an optical path separation plane that separates the illumination light and the modulated light on an optical path between the light source and the reflective light valve; and
a projection lens that enlarges and projects image information carried on the modulated light,
wherein an intersection point between an optical axis of the projection lens and the reflective light valve deviates from a center of a surface of the reflective light valve, and
a plane A is formed by a first surface normal at the center of the surface of the reflective light valve and the optical axis of the projection lens,
a plane B is vertical to the plane A and includes the optical axis of the projection lens, and
a second surface normal to a surface of the optical path separation plane is parallel to the plane B.

2. The single projection display device according to claim 1,
wherein the optical path separation plane is a polarized light separation plane, and
the illumination light is polarized to be incident on the optical path separation plane.

3. The single projection display device according to claim 1,
wherein the optical path of an illumination optical unit that illuminates the reflective light valve and includes the light source is arranged along the plane B.

4. The single projection display device according to claim 1,
wherein the optical path separation plane is arranged on the optical path between the projection lens and the reflective light valve, and
in a lens, closest to the reflective light valve, of the projection lens, a portion that is disposed opposite to the center of the surface of the reflective light valve across the optical axis is removed such that an outer circumference of the lens has a non-circular shape, as viewed from the optical path separation plane.

5. The single projection display device according to claim 1,
wherein the light source includes an LED.

6. The single projection display device according to claim 1,
wherein the light source includes a laser.

7. The single projection display device according to claim 1,
wherein the projection lens satisfies the following conditional expressions:
20<S/OBJ<65, and
2.5<β/S<10.0
where S indicates a maximum length (inch) of a magnification-side image, OBJ indicates a magnification-side projection distance (m), and β indicates a magnifying power.

8. The single projection display device according to claim 1,
wherein the projection lens satisfies the following conditional expressions:
35<S/OBJ<140,
2.5<β/S<10.0, and
3.0<S<10.0
where S indicates a maximum length (inch) of a magnification-side image, OBJ indicates a magnification-side projection distance (m), and β indicates a magnifying power.
